(19) United States
(12) Patent Application Publication
(10) Pub. No.: US 2008/0252712 A1
(43) Pub. Date: Oct. 16, 2008

(54) IMAGE FORMING ELEMENT AND FABRICATING METHOD THEREOF, AND IMAGE FORMING APPARATUS HAVING THE IMAGE FORMING ELEMENT

(76) Inventors: Su-ho Shin, Seongam-si (KR); Chang-youl Moon, Suwon-si (KR); Ki-hwan Kwon, Suwon-si (KR); Yu-man Kim, Seongnam-si (KR); Kyu-dong Jung, Suwon-si (KR)

Correspondence Address: STANZIONE & KIM, LLP, 919 18TH STREET, N.W., SUITE 440, WASHINGTON, DC, 20006, US

(21) Appl. No.: 11/855,381

(22) Filed: Sep. 14, 2007

(30) Foreign Application Priority Data
Apr. 13, 2007 (KR) 2007-36429

(51) Int. Cl. B41J 2/39

(52) U.S. Cl. 347/123

(57) ABSTRACT

An image forming element includes a drum body including a plurality of conductive layers and a plurality of insulating layers stacked on one another in an alternate pattern, in which a portion of each of the conductive layers extends towards a cavity defined within the conductive layers to form a plurality of electrodes, and a control unit disposed in the cavity, and including a plurality of electrode pads corresponding to the electrodes to provide an electrical connection to the respective electrodes. Structure and processes to fabricate an image forming element are simplified, and fabricating cost can be reduced.

### CROSS-REFERENCE TO RELATED APPLICATIONS

This application claims priority under 35 U.S.C. § 119(a) from Korean Patent Application No. 2007-0036429 filed Apr. 13, 2007 in the Korean Intellectual Property Office, the disclosure of which is incorporated herein by reference in its entirety.

### BACKGROUND OF THE INVENTION

1. Field of the Invention

The present general inventive concept relates to an image forming apparatus. More particularly, the present general inventive concept relates to an image forming element usable in a direct printing type image forming apparatus, and a fabricating method thereof.

2. Description of the Related Art

A direct type printing directly applies an image signal onto an image forming element such as an image drum, so that a latent image is formed and developed according to the applied image signal. The direct type printing does not require a light exposure device or charging device, and has stable processing.

The principle of operation of a direct printing type image forming apparatus may be found in EP0,247,699A1, and a structure and fabricating method of an image drum for use in such direct printing type image forming apparatus may be found in EP0,595,388A1 and U.S. Pat. No. 6,014,157.

FIG. 1 is a perspective view illustrating an image drum of U.S. Pat. No. 6,014,157, and FIG. 2 is an enlarged cross section of a portion of the image drum of FIG. 1.

Referring to FIGS. 1 and 2, a conventional image drum includes a drum body 10, a plurality of ring electrodes 20, and a control unit 30.

The drum body 10 has a substantially cylindrical configuration, and is made of a metallic material such as aluminum. The drum body 10 includes a plurality of passing holes 11, 12 of varying diameters, such that the passing holes 11, 12 correspond to the ring electrodes 20 respectively. A conductive material 13 is filled in the passing holes 11, 12.

The ring electrodes 20 are formed along an outer circumference of the drum body 10, and at a predetermined interval away from each other along an axis direction of the drum body 10. Each ring electrode 20 is insulated from a neighboring ring electrode 20, and also insulated from the drum body 10. The ring electrodes 20 are designed in various ways according to a desired degree of resolution, but the ring electrodes 20 are arranged along the axis direction of the drum body 10, generally at pitches approximately of 40 μm to achieve a resolution of 600 dpi.

The control unit 30 is housed in the drum body 10, and has a terminal 31. The terminal 31 is electrically connected with the ring electrodes 20 by the conductive material 13 and zebra-strips 15. The control unit 30 applies appropriate voltage to the ring electrodes 20 according to the image information, and as a result, a latent image is formed on the image drum.

Although it is possible to design an image forming element in a variety of ways, by variably constructing the ring electrodes 20 according to a desired resolution, conventionally, holes which are approximately 20 μm in width are required to be formed on a surface of the image forming element at the cycle approximately of 42.3 μm, to construct the ring electrodes 20 to achieve resolution approximately of 600 dpi. Passing holes 11, 12 have to be formed on the circumferential surface of the drum body 10 to electrically connect the ring electrodes 20 with the control unit 30. Additionally, conductive material 13 has to be filled in the passing holes 11, 12. As a result, a conventional image forming element requires complicated structure and fabricating process, which is accompanied with many fabricating works and high cost.

Additionally, electrode pads (not illustrated) of the control unit 30 are generally fabricated with less precision than the ring electrodes 20. Therefore, a plurality of control units are mounted to electrically connect the electrode pads and the ring electrodes 20. This inevitably increases diameter of an image forming element, and because the pitches of the ring electrodes 20 frequently mismatches with the pitches of the electrode pads of the control unit 30, fabricating process has difficulties such as an uneasy electric connection, or the like.

### SUMMARY OF THE INVENTION

The present general inventive concept provides an image forming element and a fabricating method thereof, which reduces fabricating cost by simplifying structure and a fabricating process.

The present general inventive concept also provides an image forming element and a fabricating method thereof, which provides compactness.

The present general inventive concept also provides an image forming apparatus having the above image forming element.

Additional aspects and utilities of the present general inventive concept will be set forth in part in the description which follows and, in part, will be obvious from the description, or may be learned by practice of the general inventive concept.

The foregoing and/or other aspects, features and/or utilities of the present general inventive concept may be achieved by providing an image forming element, which may include a drum body including a plurality of conductive layers and a plurality of insulating layers stacked on one another in an alternate pattern, in which a portion of each of the conductive layers extends towards a cavity defined within the conductive layers to form a plurality of electrodes, and a control unit disposed in the cavity, and including a plurality of electrode pads corresponding to the respective electrodes to provide an electrical connection to the respective electrodes.

The conductive layers and the insulating layers may be stacked on one another along an axis of the drum body.

Each of the conductive layers and each of the insulating layers attached to the conductive layer may form a basic unit, and a plurality of the basic units may be stacked on one another.

The conductive layers and the insulating layers may be stacked on one another and then processed to form a drum body of a predetermined length by one of heating, pressing and bonding.

A guide member may further be provided, to guide the conductive layers and the insulating layers so that the conductive layers and the insulating layers are aligned with respect to each other during stacking.

The guide member includes an insulating material.

The conductive layers and the insulating layers may include at least one guide hole formed therein through which the guide member is inserted.

A portion of each of the insulating layers may be extended towards the cavity to correspond to each of the electrodes.

The extended portion of each of the insulating layers may have elasticity.

The insulating layers may have adhesiveness.

The insulating layers may include a polymer group.

The insulating layers may include one of polyimide, polyester, and polypropylene.

The insulating layers may include one or more insulating layers.

The insulating layers may each include an adhesive layer on an outermost side of the respective insulating layers.

The adhesive layer may be coated on at least one side of each of the insulating layers to a predetermined thickness.

The cavity may be elongated along an axis of the drum body.

The cavity may be formed by cutting the conductive layers and the insulating layers by press processing.

The electrodes may protrude from at least one side of the cavity.

The electrodes may be bent and electrically connected with the electrode pads of the control unit which is inserted in the cavity.

The electrodes have a predetermined degree of elasticity.

The electrodes may be longer than an interval between the control unit and one side of the cavity.

The electrodes may be arranged in the cavity in at least one row.

The electrodes may be in an alternating position.

The electrodes adjacent to each other may be arranged in different rows from each other.

The control unit may include a substrate, a plurality of electrode pads formed on the substrate to correspond to the electrodes, and a control chip mounted on the substrate, to control voltage being applied to the electrodes through the electrode pads.

The electrode pads may be arranged in at least one row to correspond to the respective electrodes.

The electrode pads may be in an alternating position.

The electrode pads may be formed on one side or on both sides of the substrate.

The electrode pads may include an upper portion coated with a solder layer.

An underfill material may be filled between the electrode pads.

The underfill material may include an epoxy resin.

A support member may be provided in the cavity to support the substrate.

The support member may be arranged on a back of the substrate.

An elastic member may be interposed between the substrate and the support member.

A plurality of elastic members may be arranged along an axis of the drum body.

The elastic member may include at least one of a coil spring, a plate spring, and a sponge.

A protective layer may be formed on an outer circumference of the drum body.

The foregoing and/or other aspects, features and/or utilities of the present general inventive concept may also be achieved by providing an image forming apparatus, which may include a toner feed unit, an image forming element to which a toner from the toner feed unit is adhered, an image developing unit to develop an image on the image forming element, by separating at least a portion of the adhered toner from the image forming element, and an image transfer unit to transfer the developed image from the image forming element onto a printing medium. The image forming element may include a drum body including a plurality of conductive layers and a plurality of insulating layers stacked on one another in an alternate pattern, in which a portion of each of the conductive layers is extended towards a cavity defined within the conductive layers to form a plurality of electrodes, and a control unit disposed in the cavity, and including a plurality of electrode pads corresponding to the respective electrodes to provide for an electrical connection.

A toner recovery unit may further be provided, to return the toner to the toner feed unit when the toner is separated from the image forming element by the image developing unit.

Each of the conductive layers and each of the insulating layers attached to the conductive layer may form a basic unit, and a plurality of the basic units may be stacked on one another.

A guide member may further be provided, to guide the conductive layers and the insulating layers so that the conductive layers and the insulating layers are aligned with respect to each other during stacking.

The conductive layers and the insulating layers may include at least one guide hole formed therein through which the guide member is inserted.

A portion of each of the insulating layers may be extended towards the cavity to correspond to each of the electrodes.

The extended portion of each of the insulating layers may have elasticity.

The insulating layers may include one or more insulating layers.

The insulating layers may each include an adhesive layer on an outermost side.

The cavity may be elongated along an axis of the drum body.

The electrodes may protrude from at least one side of the cavity.

The electrodes may be arranged in the cavity in at least one row.

The electrodes may be in an alternating position.

The control unit may include a substrate, a plurality of electrode pads formed on the substrate to correspond to the electrodes, and a control chip mounted on the substrate, to control voltage being applied to the electrodes through the electrode pads.

The electrode pads may be arranged in at least one row to correspond to the electrodes.

The electrode pads may be in an alternating position.

The electrode pads may be formed on one side or on both sides of the substrate.

The electrode pads may include an upper portion coated with a solder layer.

An underfill material may be disposed between the electrode pads.

The underfill material may include an epoxy resin.

An elastic member may be interposed between the substrate and the support member.

A protective layer may be formed on an outer circumference of the drum body.

The foregoing and/or other aspects, features and/or utilities of the present general inventive concept may also be achieved by providing a method to fabricate an image forming element, the method including preparing a plurality of conductive layers and a plurality of insulating layers, cutting the conductive layers and the insulating layers by a predetermined processing, so that the conductive layers and the insulating layers are patterned to have a cross section of a drum and each have a cavity and an electrode therein, stacking the processed conductive layers and insulating layers in an alternate pattern, molding the conductive layers and the insulating layers in the stack by heat or pressure to obtain a drum body of a predetermined length, inserting a control unit in a cavity of the drum body, and aligning such that electrode pads of the control unit and the electrode are electrically connected with each other.

The preparing may include preparing basic units including the conductive layers and the insulating layers attached to the conductive layers.

The cutting may include cutting the conductive layers and the insulating layers by press processing.

The basic units have different configurations depending on a number of electrodes thereof, and the stacking may include placing the basic units of different configurations sequentially in a stack structure.

The electrodes of the basic units may extend from different locations towards the cavities, and the stacking may include placing the basic units having these electrodes sequentially in a stack structure.

Circular processing an outer circumference of the drum body after the molding, may further be provided.

Forming a protective layer on the outer circumference of the drum body, may further be provided.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating an example of a conventional image forming element;

FIG. 2 is a cross section view illustrating a portion of the image forming element of FIG. 1;

FIG. 3 is a perspective view illustrating an image forming element according to an exemplary embodiment of the present general inventive concept;

FIG. 4 is a front view of FIG. 3;

FIG. 5 is a view illustrating an interior of a drum body illustrated in FIG. 3;

FIG. 6 is a view illustrating basic units stacked on one another, in varying configurations according to a number of electrode rows according to an exemplary embodiment of the present general inventive concept;

FIG. 7 is a view illustrating a basic unit having two insulating layers according to an exemplary embodiment of the present general inventive concept;

FIG. 8 is a plan view illustrating a control unit illustrated in FIG. 3;

FIG. 9 is a cross section taken on line IX-IX of FIG. 3;

FIGS. 10 to 12 are views illustrating a control unit being mounted inside the drum body according to exemplary embodiments of the present general inventive concept;

FIGS. 13A to 13F are views illustrating a method to fabricate an image forming element according to an exemplary embodiment of the present general inventive concept;

FIG. 14 is a view illustrating an image forming apparatus having an image forming element according to an exemplary embodiment of the present general inventive concept; and

FIG. 15 is a flowchart illustrating a method to fabricate an image forming element according to an embodiment of the present general inventive concept,

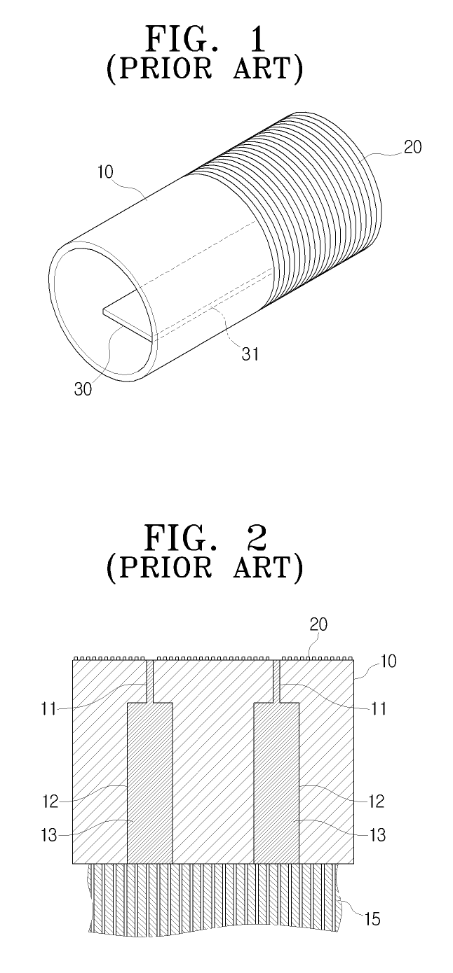

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

The following description, including description of a detailed construction and elements thereof, are provided as detailed examples to assist in a comprehensive understanding. Thus, it is apparent that the present general inventive concept may be carried out without requiring the particular details of the examples and may be carried out by a myriad of other implementations. Also, well-known functions or constructions may be omitted to provide a clear and concise description of exemplary embodiments of the present general inventive concept.

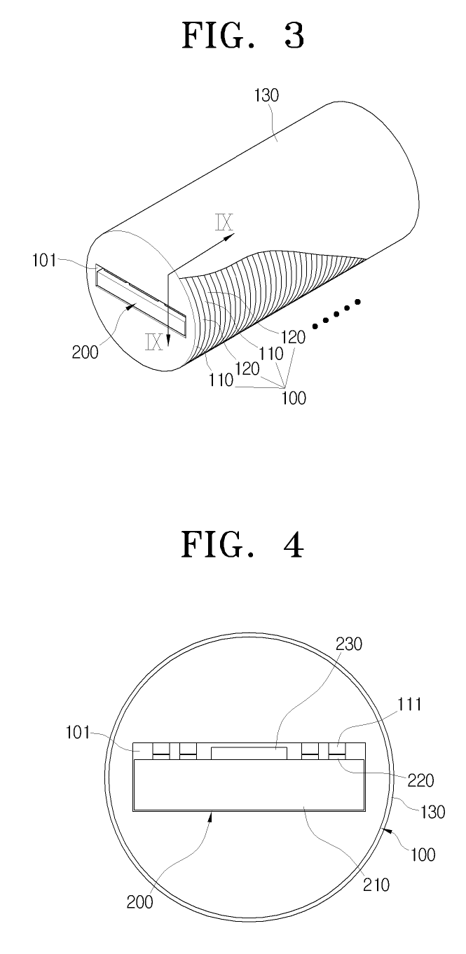

Referring to FIGS. 3 to 9, an image forming element according to an exemplary embodiment of the present general inventive concept includes a drum body 100, and a control unit 200. The image forming element may be applied to a direct printing type image forming apparatus.

The drum body 100 is formed by stacking a plurality of conductive layers 110 and insulating layers 120 in an alternate pattern, and includes a cavity 101 therewithin. The cavity 101 may be formed along an axis of the drum body 100. The cavity 101 may be formed by press-processing certain portions of the conductive layers 110 and the insulating layers 120, such as a center. The drum body 100 is wrapped by a protective layer 130 on an outer circumference.

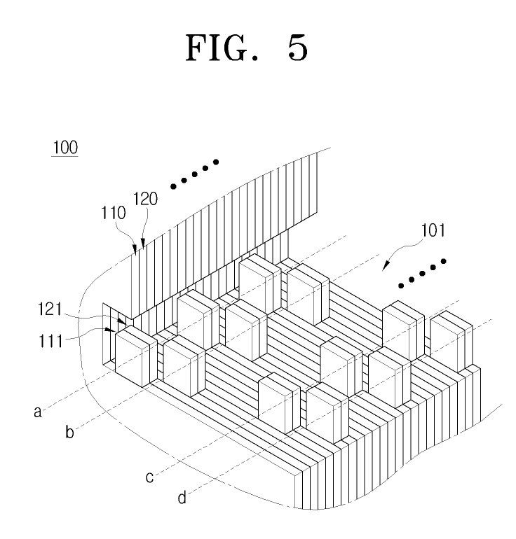

The conductive layers 110 may be thin layers, and have substantially circular cross-sections. The conductive layers 110 may be formed of metal material such as aluminum or copper, or conductive polymer. The conductive layers 110 partially extend to the cavity 101, and thus form a plurality of electrodes 111. The electrodes 111 protrude from one side of the cavity 101, for example, from an upper side and/or lower side of the cavity 101. The electrodes 111 extend longer than a gap between the electrodes and one side of the cavity 100. A plurality of electrodes 111 may be arranged in one or more rows in the cavity 101. For example, four rows (a, b, c, d) of the electrodes 111 may be arranged in a pattern as illustrated in FIG. 5, in which the electrodes 111 in adjacent rows are in alternating positions. Allowable pitches of electrode pads 220 are then determined, according to a number of electrode rows which are provided according to the desired resolution of the image forming element. For example, if resolution of the image forming element is 600 dpi, and the electrodes 111 are arranged in one, two, four, or eight rows, the allowable pitches of the electrode pads 220 are 42.3 μm, 84.6 μm, 169.2 μm, and 338.4 μm, respectively. That is, greater allowable pitches are provided, as a number of electrode rows increases. As a surface area of the electrode pads 220 accordingly increases, better connection is provided between the electrodes 111 and wiring the electrode pads 220 becomes easier. The electrodes 111 have elasticity so that the electrodes 111 can deform by contact with the electrode pads 220 when the control unit 200 is inserted in the cavity 101.

The insulating layers 120 have the configurations conforming to the conductive layers 110. For example, the insulating layers 120 may be formed as thin layers having substantially circular cross sections, and partially extending to the cavity 101 to correspond to the respective electrodes of the conductive layers 110. The extensions 121 of the insulating layers 120 deforms together with the electrodes 111, when the electrodes 111 are connected to the electrode pads 220, to insulate the electrodes 111 from the conductive layers 110. The insulating layers 120 are made of flexible materials that have elasticity. For example, the insulating layers 120 may be made of a material from a polymer group, such as a polyimides, polyester, or polypropylene.

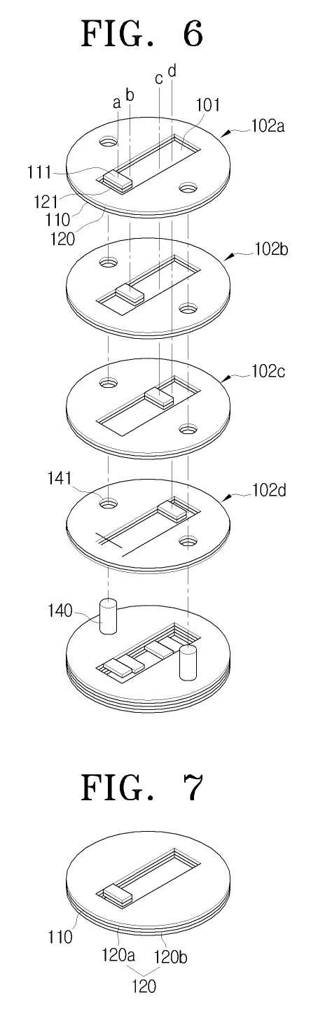

The conductive layers 110 and the insulating layers 120 are stacked on one another in an alternating manner, and adhered to each other by heat or pressure. As a result, the drum body 100 is formed. Referring to FIG. 6, the conductive layers 110 and the insulating layers 120 include basic units 102a, 102b, 102c, 102d of varying configurations according to the number of the electrode rows, and the basic units 102a, 102b, 102c, 102d are stacked on one another in sequence. The basic units 102a, 102b, 102c, 102d have the electrodes 111 extending from different locations to the cavity 101 such that, when stacked on one another in an alternating pattern, the adjacent electrodes 111 extending from the first and second basic units 102a, 102b, the second and third basic units 102b, 102c, the third and fourth basic units 102c, 102d, and the fourth and first basic units 102d, 102a, are in alternating positions. According to the present embodiment, an image forming element may have a bar-type guide member 140 to guide the conductive layers 110 and the insulating layers 120 when the layers 110, 120 are stacked on one another. The conductive layers 110 and the insulating layers 120 each have at least one guiding hole 141 so that the guide member 140 passes therethrough. The guide member 140, for example, is made of the same insulating material as that of the insulating layers 120. The insulating layers 120 include at least one layer, and include a bonding layer on the outermost layer so that the basic units 102a, 102b, 102c, 102d are attached to each other. FIG. 7 illustrates an exemplary embodiment where one conductive layer 110 with the two insulating layers 120a, 120b form one basic unit, and the outermost insulating layer 120b is formed as a bonding layer. However, various alternative configurations are possible. The bonding layer may be a coating layer of a predetermined thickness, on at least one side of the inner insulating layer 120a to a predetermined thickness.

Diameter and length of the drum body 100, and the pitch of the electrodes 111 are adequately adjustable according to a structure or resolution of an image forming apparatus.

The control unit 200 is inserted in the cavity 101. The control unit 200 includes a substrate 210, electrode pads 220 and control chips 230.

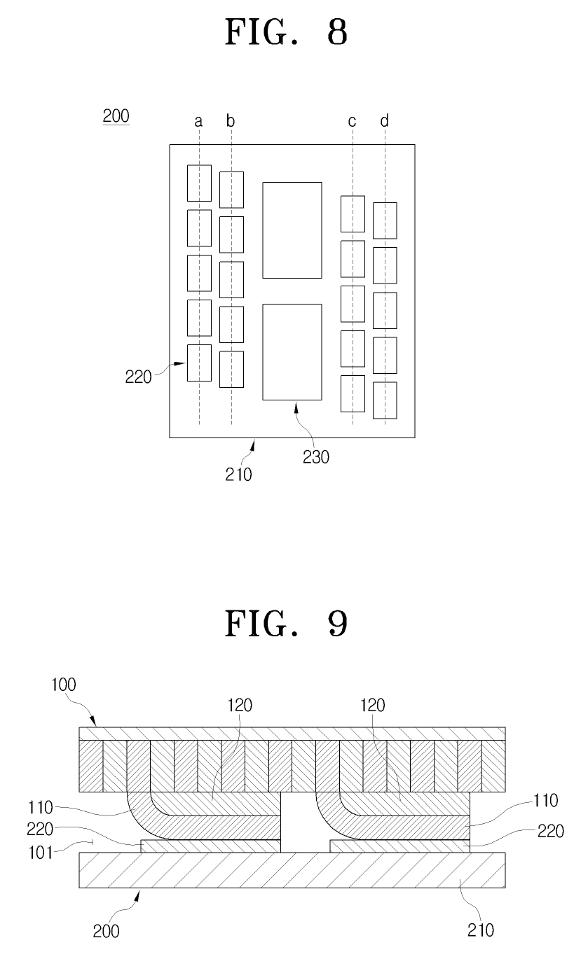

More specifically, a plurality of electrode pads 220 are provided on one or both sides of the substrate 210 corresponding to the electrodes 111 of the drum body 100, for electrical connection. The electrode pads 220 are arranged in at least one row, and if the electrode pads 220 are arranged in more than one row, the electrode pads 220 of the adjacent rows are in alternating position. For example, referring to FIG. 8, if the electrode pads 220 are in four rows (a, b, c, d), two rows of electrode pads 220 may be formed on the left side of the control chips 230, while the other two rows of electrode pads 220 are formed on the right side of the control chips 230. And the electrode pads 220 of adjacent rows (a and b, and c and d) are in an alternating position. A solder layer (not illustrated) is coated on an upper portion of the electrode pads 220 to facilitate the connection between the electrode pads 220 and the electrodes 111. For the purpose of protection of the electrodes 111 connected with the electrode pads 220, and for many other purposes such as impact reduction, connection reliability against temperature stress, and electric insulation, underfill material (not illustrated) such as an epoxy resin is also disposed between the electrode pads 220. The underfill material is well known, and therefore, will not be explained below for the sake of brevity.

The control chips 230 are mounted on the substrate 210, and control the voltage being applied to the electrodes 110 through the electrode pads 220.

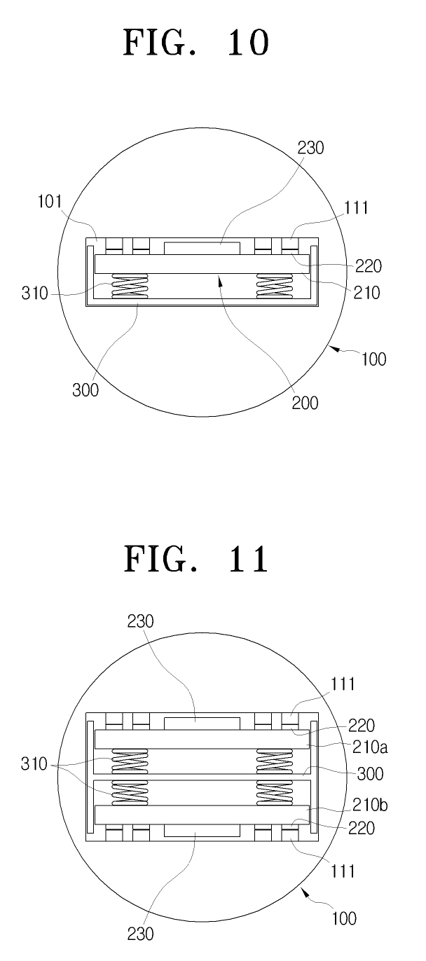

FIGS. 10 to 12 are views illustrating a control unit being mounted inside the drum body according to exemplary embodiments of the present general inventive concept.

The control unit 200 is formed in the cavity 101 of the drum body 100, and supported by supporting members 300. Referring to FIG. 10, if one substrate 210 is disposed in the cavity 101, the support members 300 are placed on a lower side of the substrate 210, so that the electrode pads 220 of the substrate 210 are connected with the electrodes 111 formed on an upper side of the cavity 101. An elastic member 310 is disposed between the substrate 210 and the support members 300 to elastically support the substrate 210 in an upward direction. A plurality of elastic members 310 may be arranged along an axis of the drum body 100. The elastic member 310 may be one of a coil spring, a plate sprint, and a sponge. Referring to FIG. 11, if two substrates 210a, 210b are provided in the cavity 101, the support members 300 are disposed between the two substrates 210a, 210b, so that the electrode pads 220 of the upper and lower substrates 210a, 210b are connected with the electrodes 111 formed on the upper and lower sides of the cavity 101, respectively. The elastic member 310 is disposed between the upper and lower substrates 210a, 210b and the support members 300, to elastically support the upper and lower substrates 210a, 210b in upward and downward directions, respectively. Referring to FIG. 12, an image forming element according to an exemplary embodiment may include electrodes 111 formed on upper and lower sides of the cavity 101, and electrode pads 220 formed on opposite sides of the substrate 210 to correspond to the electrodes 111.

Although not illustrated in the drawings, a restraining member, such as a cover, may be provided, by being fixed to both ends of the drum body 100, to prevent movement of the control unit 200 within the cavity 101 along the axis of the drum body 100.

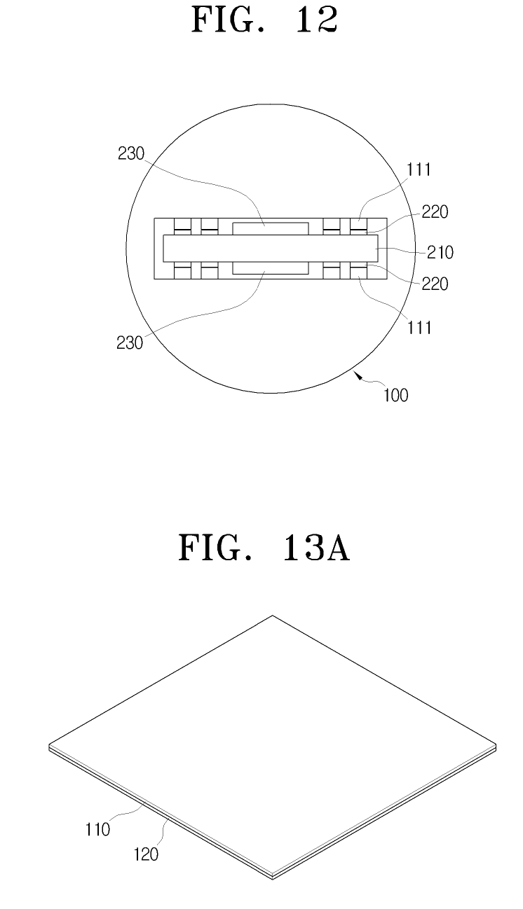

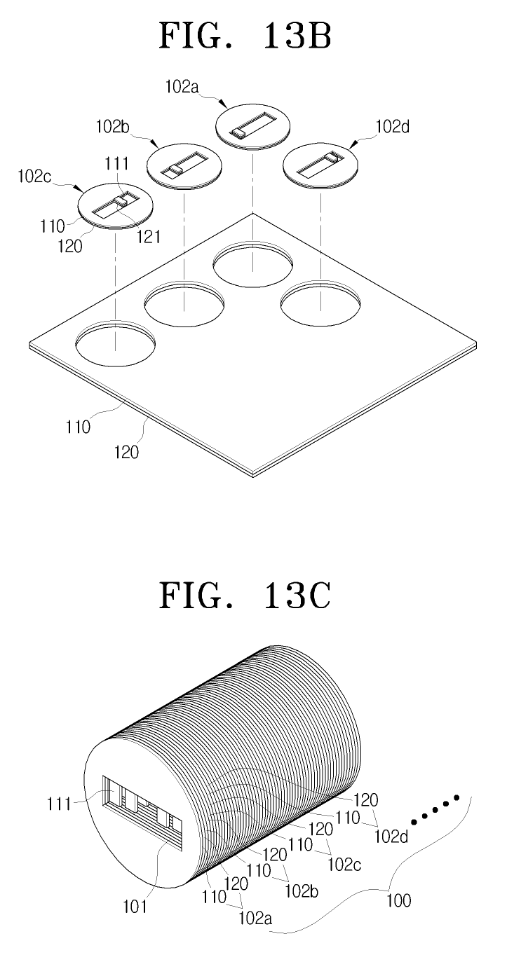

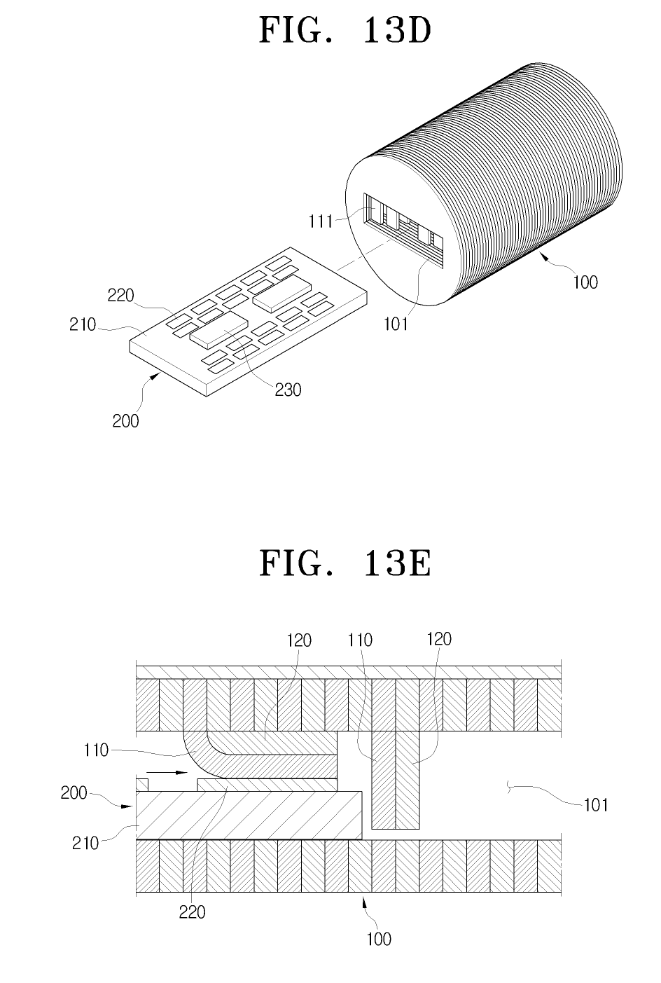

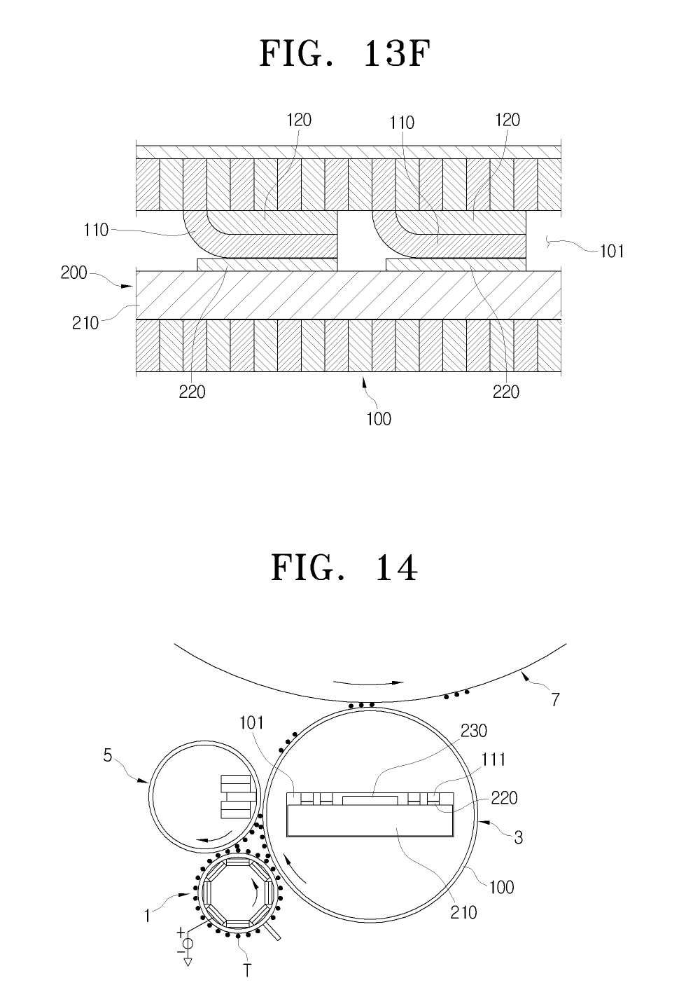

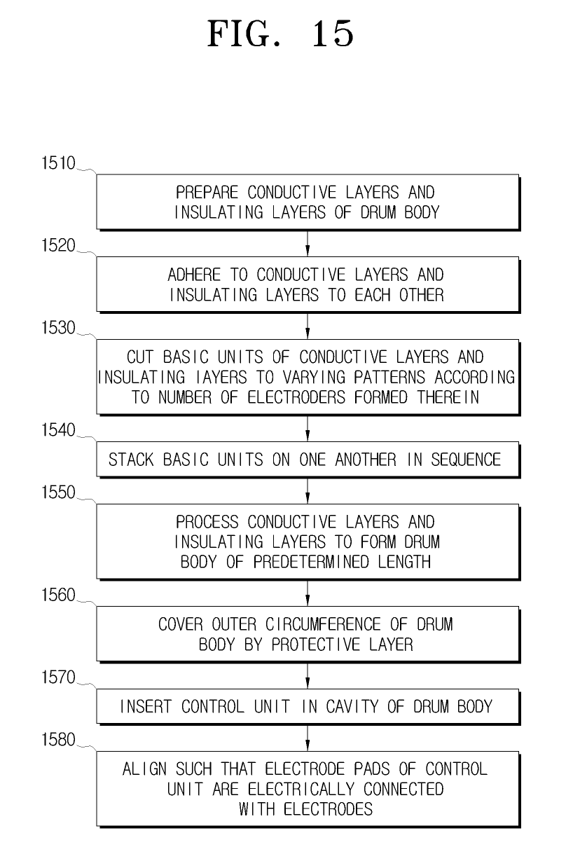

A method to fabricate an image forming element according to the exemplary embodiments of the present general inventive concept will be explained below, with reference to FIGS. 13A-13F and 15.

Referring to FIGS. 13A-13F and 15, a plurality of conductive layers 110 and insulating layers 120 of the drum body 100 are prepared (operation 1510). The conductive layers 110 and the insulating layers 120 may be prepared separately from each other. Alternatively, the conductive layers 110 and the insulating layers 120 may be attached to each other at one end, and provided together as one basic unit of the drum body 100. The conductive layers 110 and the insulating layers 120 may be adhered to each other (operation 1520), or the conductive layers 110 may be fixed to one side of the insulating layers 120 by processes such as chemical vapor deposition (CVD), sputtering, or plating. Alternatively, the insulating layers 120 may be coated on one side of the conductive layers 110. The basic units of conductive layers 110 and insulating layers 120 are cut to have a cross section of a drum by press-processing, forming cavities 101 and the electrodes 111, respectively. Accordingly, the basic units of conductive layers 110 and insulating layers 120 are cut to varying patterns, according to the number of electrodes 111 formed therein (operation 1530). That is, the basic units are cut differently, so that the electrodes 111 extending towards the cavity 101 are arranged in different rows from each other. With reference to FIG. 6, a plurality of basic units, for example, the four basic units 102a, 102b, 102c, 102d are stacked on one another in sequence, thereby making four rows of the electrodes 111 (operation 1540). The conductive layers 110 and the insulating layers 120 are then processed to form the drum body 100 of a predetermined length, by heating or pressing (operation 1550). The outer circumference of the drum body 100 may be circular-processed, and covered by the protective layer 130 (FIG. 3) (operation 1560). The control unit 200 is inserted in the cavity 101 of the drum body 100 (operation 1570), and aligned such that the electrode pads 220 of the control unit 200 are electrically connected with the electrodes 111 (operation 1580).

Referring to FIG. 14, a direct printing type image forming apparatus according to an example of the present general inventive concept may include a toner feed unit 1, an image forming element 3 having the structure where toner T of the toner feed unit 1 is adhered as explained above, an image developing unit 5 which separates at least a portion of the toner T of the image forming element 3 to form an image on the image forming element 3, an image transfer unit 7 which transfers the developed image of the image forming element 3 onto a printing medium such as a sheet of paper, and a toner recovery unit (not illustrated) which recovers the toner T separated from the image forming element 3 by the image developing unit 5 back to the toner feed unit 1. The toner feed unit 1, the image developing unit 5, the image transfer unit 7 and the toner recovery unit are well known, and therefore, detailed explanation thereof will be omitted for the sake of brevity.

As explained above, according to various embodiments of the present general inventive concept, the conductive layers and the insulating layers are stacked on one another in an alternate pattern to form a drum body, and a portion of the conductive layers are extended inwards to electrically connect to the control unit. As a result, the structure and fabricating process are simper, and fabricating cost is reduced.

Furthermore, by arranging the electrodes in a plurality of rows in a manner that the adjacent electrodes are in alternating position, allowable pitches, that is the surface area of the electrode pads corresponding to the electrodes, is increased. As a result, connection between the electrodes and the electrode pads is facilitated.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming element, comprising:
a drum body including a plurality of conductive layers and a plurality of insulating layers stacked on one another in an alternate pattern, in which a portion of each of the conductive layers extends towards a cavity defined within the conductive layers to form a plurality of electrodes; and
a control unit disposed in the cavity and including a plurality of electrode pads corresponding to the respective electrodes to provide an electrical connection to the respective electrodes.

2. The image forming element of claim 1, wherein each of the conductive layers and each of the insulating layers attached to the conductive layer forms a basic unit, and a plurality of the basic units are stacked on one another.

3. The image forming element of claim 1, comprising:
a guide member to guide the conductive layers and the insulating layers so that the conductive layers and the insulating layers are aligned with respect to each other during stacking.

4. The image forming element of claim 1, wherein the insulating layers comprise:
one or more insulating layers.

5. The image forming element of claim 1, wherein the electrodes are arranged in the cavity in at least one row.

6. The image forming element of claim 5, wherein the electrodes are in an alternating position.

7. The image forming element of claim 1, wherein the electrodes adjacent to each other are arranged in different rows from each other.

8. The image forming element of claim 1, wherein the control unit comprises:
a substrate;
a plurality of electrode pads formed on the substrate to correspond to the electrodes; and
a control chip mounted on the substrate, to control voltage being applied to the electrodes through the electrode pads.

9. The image forming element of claim 8, wherein the electrode pads are formed on one side or on both sides of the substrate.

10. The image forming element of claim 8, comprising:
a support member provided in the cavity to support the substrate.

11. The image forming element of claim 1, wherein a protective layer is formed on an outer circumference of the drum body.

12. An image forming apparatus, comprising:
a toner feed unit;
an image forming element to which a toner from the toner feed unit is adhered;
an image developing unit to develop an image on the image forming element, by separating at least a portion of the adhered toner from the image forming element; and
an image transfer unit to transfer the developed image from the image forming element onto a printing medium, wherein
the image forming element comprises,
a drum body including a plurality of conductive layers and a plurality of insulating layers stacked on one another in an alternate pattern, in which a portion of each of the conductive layers is extended towards a cavity defined within the conductive layers to form a plurality of electrodes, and
a control unit disposed in the cavity, and including a plurality of electrode pads corresponding to the respective electrodes to provide for an electrical connection.

13. The image forming apparatus of claim 12, further comprising:
a toner recovery unit to return the toner to the toner feed unit when the toner is separated from the image forming element by the image developing unit.

14. The image forming apparatus of claim 12, wherein each of the conductive layers and each of the insulating layers attached to the conductive layer forms a basic unit, and a plurality of the basic units are stacked on one another.

15. The image forming apparatus of claim 12, wherein the electrodes are arranged in the cavity in at least one row.

16. The image forming apparatus of claim 15, wherein the electrodes are in an alternating position.

17. A method to fabricate an image forming element, the method comprising:
preparing a plurality of conductive layers and a plurality of insulating layers;
cutting the conductive layers and the insulating layers by a predetermined processing, so that the conductive layers and the insulating layers are patterned to have a cross section of a drum and each have a cavity and an electrode therein;
stacking the processed conductive layers and insulating layers in an alternate pattern;
molding the conductive layers and the insulating layers in the stack by heat or pressure to obtain a drum body of a predetermined length;
inserting a control unit in a cavity of the drum body; and
aligning such that electrode pads of the control unit and the electrode are electrically connected with each other.

18. The method of claim 17, wherein the preparing comprises:
preparing basic units including the conductive layers and the insulating layers attached to the conductive layers.

19. The method of claim 17, wherein the cutting comprises:
cutting the conductive layers and the insulating layers by press processing.

20. The method of claim 17, wherein:
the basic units have different configurations depending on a number of electrodes thereof; and
the stacking comprises:
placing the basic units of different configurations sequentially in a stack structure.

21. The method of claim 20, wherein:
the electrodes of the basic units extend from different locations towards the cavities; and
the stacking comprises:
placing the basic units having these electrodes sequentially in a stack structure.

22. The method of claim 17, further comprising:
circular processing an outer circumference of the drum body after the molding.

23. The method of claim 22, further comprising:
forming a protective layer on the outer circumference of the drum body.
